(19) United States
(12) Patent Application Publication
(10) Pub. No.: US 2008/0225340 A1
(43) Pub. Date: Sep. 18, 2008

(54) Image processing apparatus, image processing method, and computer program product

(75) Inventor: Yoshihisa Ohguro, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/071,346

(22) Filed: Feb. 20, 2008

(30) Foreign Application Priority Data
Mar. 14, 2007 (JP) 2007-065668
Dec. 17, 2007 (JP) 2007-325144

(51) Int. Cl. G06K 15/02

(52) U.S. Cl. 358/2.1

(57) ABSTRACT

An image processing apparatus includes a judging unit that judges whether a result of image processing performed on an area satisfies a certain processing end condition and a stopping unit that stops the image processing when judgment of the judging unit is affirmative.

### CROSS-REFERENCE TO RELATED APPLICATIONS

The present application claims priority to and incorporates by reference the entire contents of Japanese priority documents 2007-065668 filed in Japan on Mar. 14, 2007 and 2007-325144 filed in Japan on Dec. 17, 2007.

### BACKGROUND OF THE INVENTION

1. Field of the Invention

The present invention relates to a technology for processing a document image.

2. Description of the Related Art

A technology for extracting line blocks by performing a line extracting process on a document image, and performing a predetermined processing on the line blocks has been known.

For example, “character direction identifying device, character processing device, program, and storage medium” for promptly identifying character direction with a small-size storage and less number of calculations is disclosed in Japanese Patent Application Laid-open No. 2006-031546.

Furthermore, “language identification apparatus, program, and recording medium” for promptly discriminating languages used in a document is disclosed in Japanese Patent Application Laid-open No. 2005-063419.

Moreover, “method, device, and program for extracting title of document picture” for extracting a title candidate speedily and accurately is disclosed in Japanese Patent Application Laid-open No. 2003-058556.

However, in the technologies disclosed in Japanese Patent Application Laid-open No. 2006-031546 and Japanese Patent Application Laid-open No. 2005-063419, because a predetermined processing is performed on the whole image, the processing time tends to be long.

A technology for extracting an area from a document picture and performing a character recognition on the extracted area is disclosed in Japanese Patent Application Laid-open No. 2006-031546. However, even if this technology is applied to typical character recognition, the character recognition needs to be performed on all extracted areas. Therefore, the processing time virtually the same as performing the character recognition on the whole document picture will be required.

### SUMMARY OF THE INVENTION

It is an object of the present invention to at least partially solve the problems in the conventional technology.

According to an aspect of the present invention, there is provided an image processing apparatus that includes an image processing unit that performs a predetermined image processing on each of a plurality of areas of an input image; a judging unit that judges whether a result of image processing performed by the image processing unit on an area satisfies a certain processing end condition; a stopping unit that causes the image processing unit to stop performing the image processing when judgment of the judging unit is affirmative; and an output unit that outputs the image processing result.

According to another aspect of the present invention, there is provided an image processing method including performing a predetermined image processing on each of a plurality of areas of an input image; judging whether a result of image processing performed at the performing on an area satisfies a certain processing end condition; stopping the performing when judgment at the judging is affirmative; and outputting a result of the image processing performed at the performing.

According to still another aspect of the present invention, there is provided a computer program product that realizes the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a hardware configuration of an image processing apparatus according to an embodiment of the present invention;

FIG. 2 is a block diagram of a software configuration of the image processing apparatus shown in FIG. 1;

FIG. 3A is a schematic diagram of an example of a document image;

FIG. 3B is a schematic diagram of an example of a result of a block extraction processing;

FIG. 3C is a schematic diagram of an example of a result of a line extraction processing;

FIG. 4A is a schematic diagram of an example of a layout of a document image;

FIG. 4B is a schematic diagram for explaining dividing of the document image shown in FIG. 4A into processing areas;

FIG. 5A is a schematic diagram of an example of a color image;

FIG. 5B is a schematic diagram of an example of a binary halftone image;

FIG. 6 is a flowchart of a processing procedure according to a first example;

FIG. 7 is a flowchart of a processing procedure according to a second example;

FIG. 8 is a schematic diagram representing an example of scanning the document image in each line direction according to third and fourth examples;

FIG. 9 is a flowchart of a processing procedure according to the third example;

FIG. 10 is a flowchart of a processing procedure according to the fourth example; and

FIG. 11 is a schematic diagram of an example of network-connected image processing apparatuses according to the embodiment.

### DETAILED DESCRIPTION OF THE PREFERRED EMBODIMENTS

Exemplary embodiments of the present invention are explained in detail below with reference to the accompanying drawings.

In a case of performing a predetermined processing such as an optical character recognition (OCR) processing and a character-orientation judging processing on a document image using line data of the document image, an image processing apparatus 100 according to an embodiment can perform the predetermined processing at high speed without requiring excessive computational resource by effectively performing the predetermined processing on the document image.

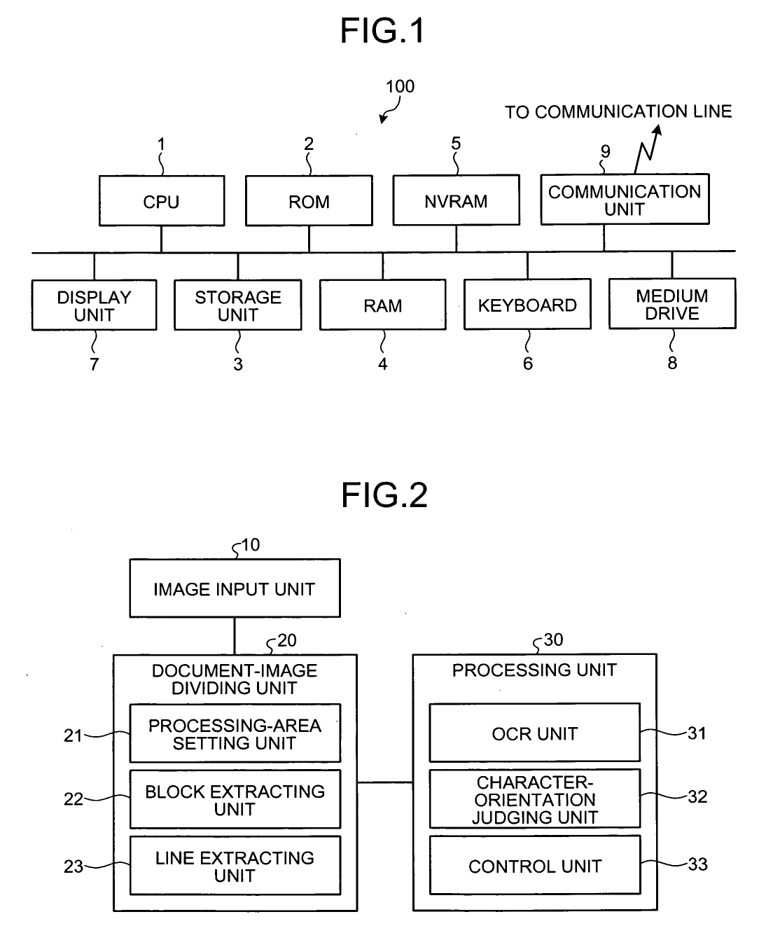

FIG. 1 is a block diagram of a hardware configuration of the image processing apparatus 100 according to an aspect of the present invention. The image processing apparatus 100 includes a central processing unit (CPU) 1, a read only memory (ROM) 2, a storage unit 3 such as a hard disk, a random access memory (RAM) 4, a nonvolatile random access memory (NVRAM) 5, a keyboard 6, a display unit 7, a medium drive 8, and a communication unit 9. The CPU 1 controls the image processing apparatus 100, the ROM 2 stores therein computer programs to run the CPU 1, the storage unit 3 stores therein a document image scanned by a scanner (not shown), a document image created by a personal computer (PC), or a document image received through a communication line, the RAM 4 temporarily reads out and develops the document image or the like stored in the storage unit 3 for image processing, the NVRAM 5 stores therein a trigram table of arrangement data obtained on training data for each reference language, the keyboard 6 receives input of various pieces of information from an operator, and the display unit 7 displays the information input by the operator. The medium drive 8 is used for reading computer programs from a CD-ROM or the like, and the communication unit 9 transmits and/or receives data, i.e., a document image, through a telecommunication line or a communication network such as the Internet and a local area network (LAN).

Characteristic functions of the image processing apparatus 100 from among the functions executed by the CPU 1 by executing various programs installed in the ROM 2 are explained below.

FIG. 2 is a block diagram of a software configuration of the image processing apparatus 100. The CPU 1 operates according to the computer programs installed in the ROM 2. In other words, when the CPU 1 executes certain computer programs installed in the ROM 2, an image input unit 10, a document-image dividing unit 20, and a processing unit 30 are created. The document-image dividing unit 20 includes a processing-area setting unit 21, a block extracting unit 22, and a line extracting unit 23, and the processing unit 30 includes an OCR unit 31, a character-orientation judging unit 32, and a control unit 33.

The image receiving unit 10 receives a document image and stores the document image into the storage unit 3 as needed. The document image can be an image acquired by the scanner, an image created by using the PC, or an image received through the communication line. The document-image dividing unit 20 receives the document image from the image receiving unit 10. Alternatively, the document-image dividing unit 20 receives the document image from the storage unit 3.

The document-image dividing unit 20 divides the document image into a plurality of processing areas, and the processing unit 30 performs a predetermined processing, such as OCR processing and/or character-orientation judging processing, on the processing areas.

Specifically, the processing-area setting unit 21 of the document-image dividing unit 20 divides the document image into a plurality of processing areas and sets each area as a processing area. The document image can be divided by specifying the number of processing areas, or by specifying a width of processing areas.

Assuming that the document image is rectangular with one apex defined by coordinates (Xs, Ys) and a diagonally opposite apex defined by coordinates (Xe, Ye), the height H of the document image will be Ye-Ys and the width W will be Xe-Xs. By specifying a number Nbh of processing areas in the height direction of the document image, the document image can be divided into Nbh number of processing areas each having a length H/Nbh in the height direction. Alternatively, by specifying a number Nbw of processing areas in the width direction of the document image, the document image can be divided into Nbw number of processing areas each having a length W/Nbw in the width direction. Values Nbv and Nbh can be set as required at the time of dividing the document image.

Instead of specifying the number of divisions, it is conceivable to specify a fixed length in the height direction or the width direction. By specifying a length H/Nbh in the height direction, the document image can be divided into Nbh number of processing areas. Alternatively, by specifying a length W/Nbw in the width direction, the document image can be divided into Nbw number of processing areas.

Subsequently, the block extracting unit 22 extracts blocks each of which circumscribes a black-pixel connected component, i.e., performs block extraction processing, and the line extracting unit 23 performs line extraction processing.

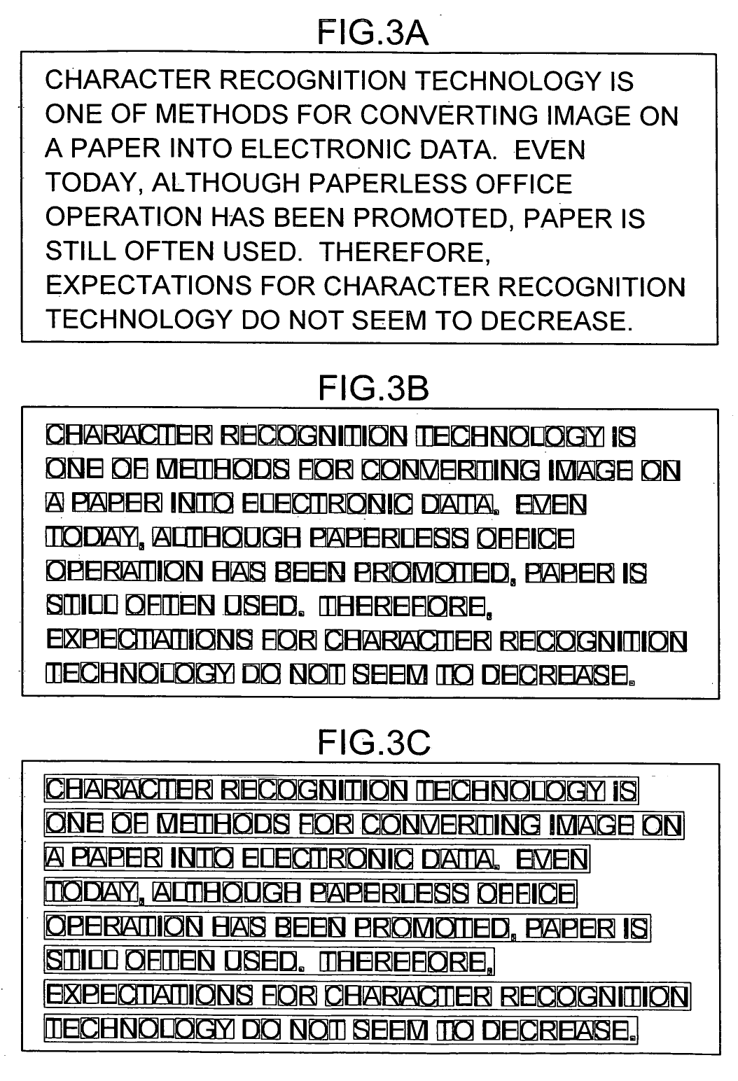

The line extraction processing performed by the line extracting unit 23 is explained below. FIG. 3A is an example of the document image, FIG. 3B is a schematic diagram for explaining the block extraction process, and FIG. 3C is a schematic diagram for explaining the line extraction process. As shown in FIG. 3B, in the block extraction process, the block extracting unit 22 extracts blocks that circumscribe a black-pixel connected component, i.e., a letter, in the document image shown in FIG. 3A. Moreover, as shown in FIG. 3C, in the line extraction process, the line extracting unit 23 extracts lines that joins the blocks in FIG. 3B within a predetermined number of pixels in the vertical direction or the horizontal direction.

A basic operation (an image processing method) of the image processing apparatus 100 is explained below.

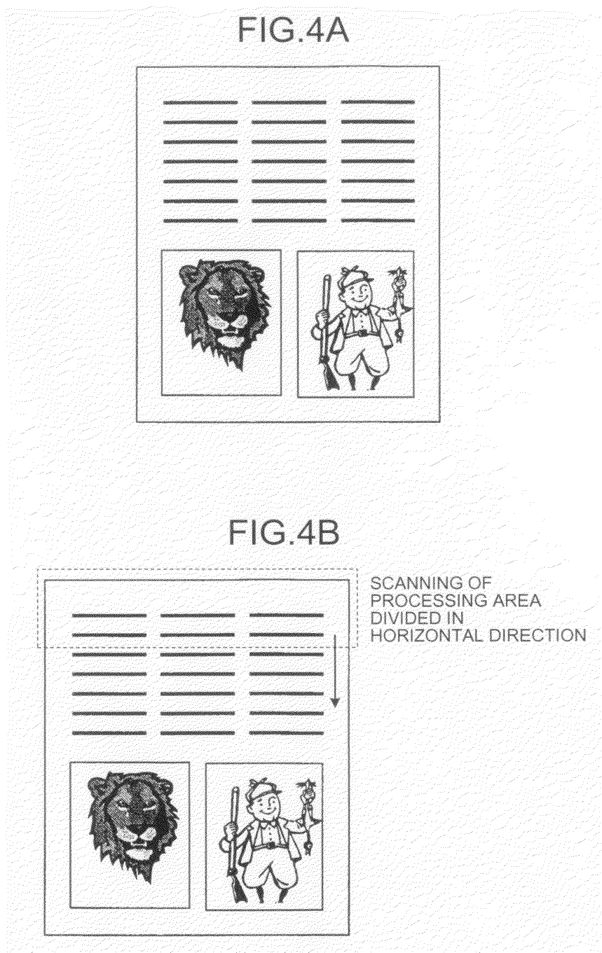

FIG. 4A is a schematic diagram of an example of a layout of the document image, and FIG. 4B is a schematic diagram for explaining dividing of the document image into a plurality of processing areas. In the present embodiment, the document-image dividing unit 20 processes the document image by processing each of the processing areas separately rather than processing the entire document image at once. However, it is permissible to have a configuration in which the document-image dividing unit 20 processes the entire document image at once.

Then, in the processing unit 30, the predetermined processing is performed for every line extracted by the line extracting unit 23, and a result of the predetermined processing is stored after the control unit 33 judges whether a non-processed line remains in the processing area. If the control unit 33 judges that there is a non-processed line, the processing unit 30 performs the predetermined processing on the non-processed line, and the control unit 33 judges whether there is a non-processed line again. If the control unit 33 judges that there is no non-processed line, the above operations are performed on the next processing area. In the present embodiment, the predetermined processing is performed for every line extracted by the line extracting unit 23; however, for example, the predetermined processing can be performed for every predetermined area. The predetermined area can be any size as long as the OCR processing and the character (line) orientation judging processing can be performed on the predetermined area.

The processing area is smaller than the whole document image, so that the number of blocks and lines in the processing area is also smaller than those in the document image. Therefore, areas for storing block data and line data that are secured in advance can be small, which is advantageous.

Moreover, by performing the predetermined processing on the lines every processing area, and storing a result of the predetermined processing for the whole document image, the areas for storing block data and line data can be repeatedly utilized.

In the basic operation of the image processing apparatus 100, the document image can be subjected to the predetermined processing based on a result of the line extraction processing without preparing a large amount of computational resource considering the maximum processing amount by diving the document image into the processing areas, and an intermediate result can be analyzed by obtaining the result of the predetermined processing in units of the processing area, enabling to decide to finish the operations early. Therefore, a user can obtain a desired result quickly with a small amount of computational resource, resulting in improving usability.

The control unit 33 (a judging unit) judges whether a result of the predetermined processing on the line extracted by the line extracting unit 23 satisfies a processing end condition of the processing by the OCR unit 31 or the character-orientation judging unit 32 every time the predetermined processing is performed on the line. In the present embodiment, the control unit 33 judges whether a result of the predetermined processing satisfies the processing end condition every time the predetermined processing is performed on the line; however, for example, the control unit 33 can judge whether a result of a predetermined processing on the predetermined area satisfies the processing end condition every time the predetermined area is processed.

The processing end condition includes a first case in which a desired result can be obtained and a second case in which a document image is not suitable as a target for processing during the predetermined processing by the OCR unit 31 or the character-orientation judging unit 32. For example, the first case includes a case in which a character string (character data) obtained by the OCR processing coincides with a preset keyword, a case in which the number of lines whose character orientation (arrangement data of blocks in lines) can be judged exceeds a threshold number of lines with which the character orientation can be judged with a predetermined reliability, and other cases. Therefore, the predetermined processing by the OCR unit 31 or the character-orientation judging unit 32 in operation can be ended before processing the whole document image, so that the time required for the predetermined processing can be shortened.

The second case includes a case in which the number of blocks in a line in the processing area (a predetermined area) exceeds a threshold number of blocks in the line existable in the processing area, and other cases. Therefore, if the number of blocks in the line exceeds the threshold number of blocks, the control unit 33 judges that the document image is not a text image, so that the predetermined processing by the OCR unit 31 or the character-orientation judging unit 32 in operation can be ended before processing the whole document image, so that unnecessary processing can be avoided.

When a result of the predetermined processing satisfies the processing end condition, the control unit 33 (a stop unit) stops the predetermined processing to non-processed lines in the processing area. Then, the control unit 33 (an output unit) outputs the result of the predetermined processing to the line as a result of the predetermined processing to the processing area. Furthermore, the control unit 33 instructs the OCR unit 31 or the character-orientation judging unit 32 to transfer to the processing to the next processing area.

Examples of processing procedures (image processing methods) are explained based on the basic operation of the image processing apparatus 100 according to the embodiment. In the present embodiment, when the processing end condition is satisfied, the predetermined processing on a line is ended. The operation of ending the predetermined processing on a line includes a case explained in a first example in which the predetermined processing in operation on a processing area is ended and thereafter, the processing is transferred to the next processing area, and a case explained in a second example in which the predetermined processing in operation on a processing area is ended and thereafter, the entire operation is finished without transferring to the processing to the next processing area.

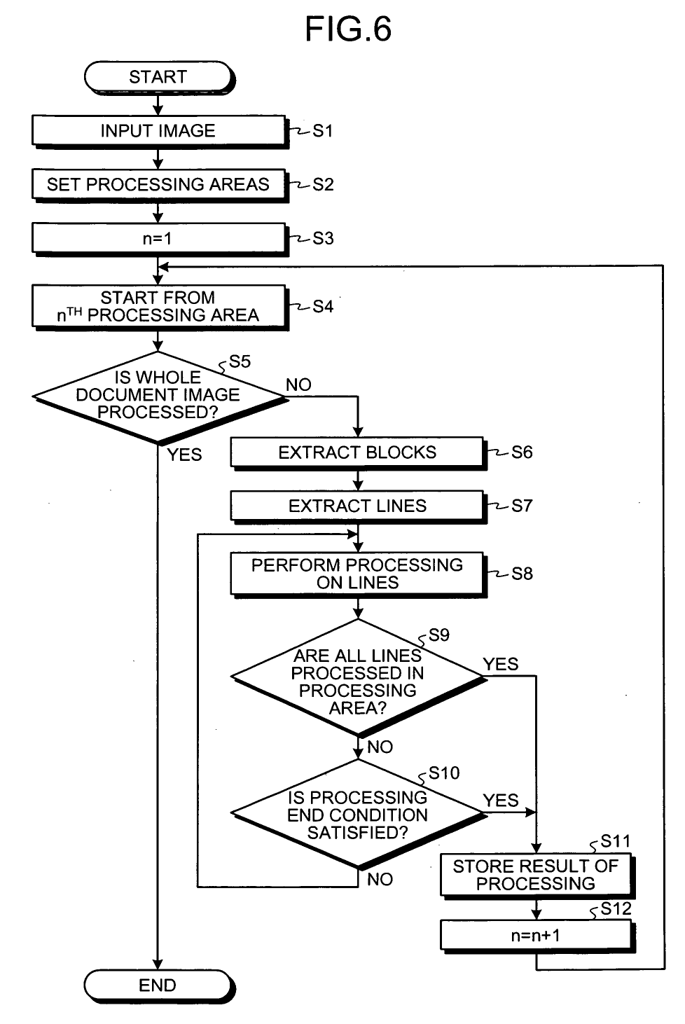

A processing procedure in the first example is explained referring to FIG. 6. FIG. 6 is a flowchart of the processing procedure according to the first example.

The document image stored in the storage unit 3 by the image input unit 10 is read out from the storage unit 3 and is input to the document-image dividing unit 20, or the document image is directly input to the document-image dividing unit 20 by the image input unit 10 (Step S1).

The document-image dividing unit 20 sets processing areas by the processing-area setting unit 21. Specifically, the processing-area setting unit 21 divides the document image into a plurality of areas, and temporarily stores the divided areas as the processing areas (Step S2). At this time, a number is assigned to each processing area, and a first processing area is processed (Steps S3 and S4).

Before performing the block extraction processing (Step S6) and the line extraction processing (Step S7) on the first processing area, the document-image dividing unit 20 judges whether the whole document image (all the processing areas) is processed (Step S5). If there is a plurality of processing areas, the document-image dividing unit 20 judges that not the whole document image is processed, i.e., there is a non-processed processing area remained (“No” at Step S5), and a system control proceeds to Step S6.

The document-image dividing unit 20 performs the block extraction processing on the first processing area by the block extracting unit 22 (Step S6). Specifically, the document-image dividing unit 20 extracts blocks each circumscribing a pixel connected component, and records coordinates of the blocks. Thereafter, the document-image dividing unit 20 performs the line extraction processing on the first processing area by the line extracting unit 23 (Step S7). Specifically, the document-image dividing unit 20 couples adjacent blocks to form lines, and records coordinates of the lines.

The processing unit 30 performs the predetermined processing such as the OCR processing by the OCR unit 31 and the character-orientation judging processing by the character-orientation judging unit 32 on the lines extracted by the line extraction processing (Step S8).

The processing unit 30 judges whether the predetermined processing is performed on all the lines in the first processing area (Step S9).

When the processing unit 30 judges that the predetermined processing is performed on all the lines in the first processing area (“Yes” at Step S9), a result of the predetermined processing is stored in the storage unit 3 (Step S11). Then, a second processing area is taken as a target (Step S12), and the processing from Step S4 is performed on the second processing area in the same manner as the above.

When the processing unit 30 judges that the predetermined processing is not performed on all the lines in the first processing area (“No” at Step S9), the processing unit 30 judges whether the processing end condition to end the predetermined processing in operation is satisfied (Step S10).

As described above, the processing end condition includes the case in which a desired result can be obtained while the predetermined processing is performed, examples of which are a case in which a result of the OCR processing coincides with the preset keyword, and a case in which the number of lines whose character orientation is judged exceeds the predetermined threshold.

The character-orientation judging processing by the character-orientation judging unit 32 is explained in detail.

After a line is extracted, the character-orientation judging unit 32 calculates the height of each block in the line, and estimates the maximum line height in case that the line is skewed or blocks in the line are all small. A height h of each block in the line is multiplied by a predetermined value A (e.g. 1.2), which is compared with an actual line height H. If the value calculated by multiplying the maximum block height hs by the predetermined value A is larger than the actual line height H, the maximum block height hs is regarded as the actual line height H. Next, a base line of the line is determined by calculating a regression line of end points Ye of the blocks in the line. At this time, only the end points Ye that are lower than the half of the height of the line are used. The calculated regression line is regarded as the base line of the line. Then, the blocks in the line are aligned according to start points Ys of the blocks. The arrangement data of the aligned blocks is quantized to convert the blocks into a symbol sequence. The appearance probability is calculated from the symbol sequence in all possible character orientations.

When the processing unit 30 judges that the processing end condition is not satisfied (“No” at Step S10), a control system returns to Step S8, and the processing unit 30 continues the predetermined processing to non-processed lines in the first processing area.

When the processing unit 30 judges that the processing end condition is satisfied (“Yes” at Step S10), the processing unit 30 ends the predetermined processing in operation, and the control system proceeds to Step S11 at which a result of the predetermined processing performed thus far is stored in the storage unit 3. Then, the second processing area is taken as a target (Step S12), and the processing from Step S4 is performed on the second processing area in the same manner as the above. In other words, when it is judged that the processing end condition is satisfied, the predetermined processing in operation for the processing area is ended, and a target for processing is transferred to the next processing area.

When it is judged that the whole document image (all the processing areas) is processed, i.e., there is no non-processed processing area remained (“Yes” at Step S5), the entire operation is finished.

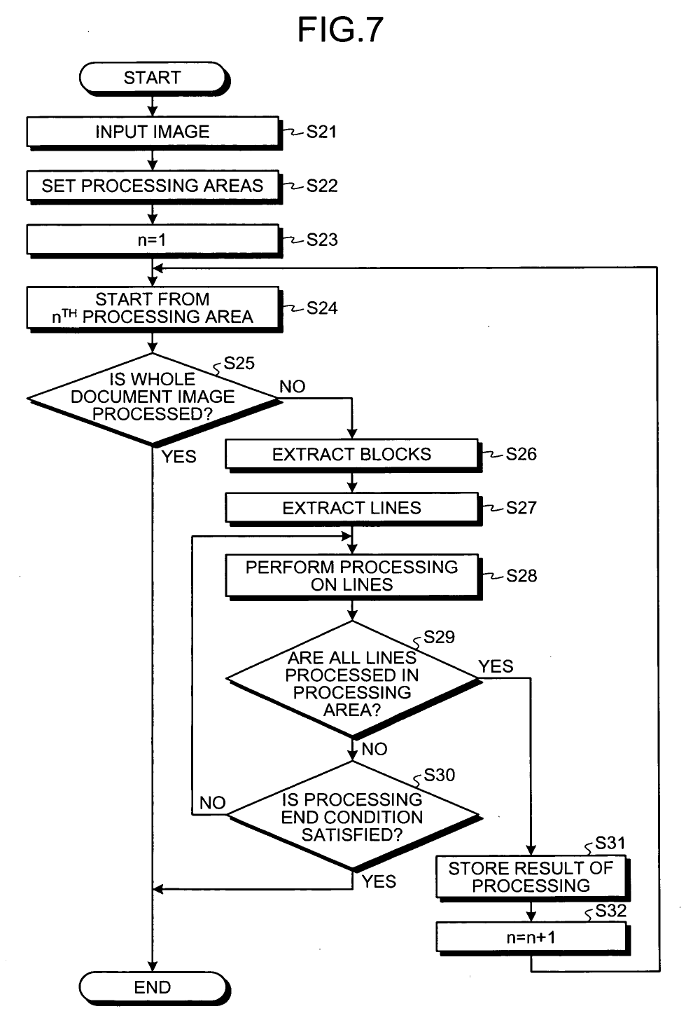

A processing procedure in the second example is explained referring to FIG. 7. FIG. 7 is a flowchart of the processing procedure according to the second example.

The processing at Steps S21 to S32 shown in FIG. 7 in the second example is performed in the same manner as those at Steps S1 to S12 shown in FIG. 6 in the first example except the following point, so that the explanations of the same processing are omitted. In the second example, when the processing unit 30 judges that the processing end condition is satisfied (“Yes” at Step S30), the predetermined processing in operation is ended, and the entire operation is finished without transferring to the processing to the next processing area.

If the blocks extracted as shown in FIG. 3B are coupled in the vertical direction, vertical lines are formed.

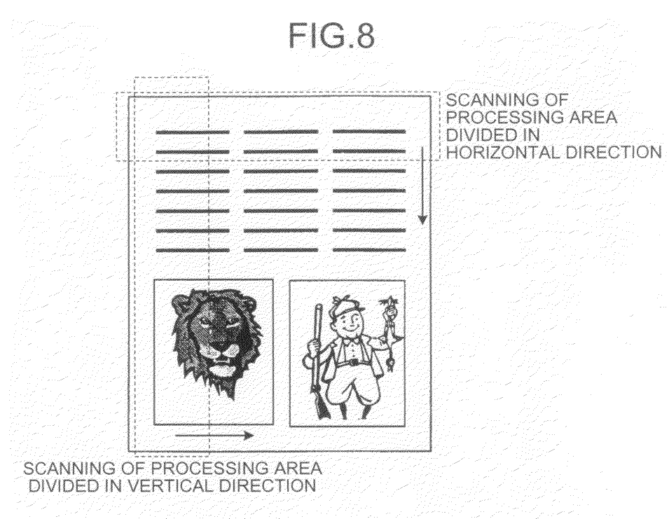

In a third example, as shown in FIG. 8, the predetermined processing is performed on the document image considering both of a horizontal writing and a vertical writing, so that a line extraction processing per unit area can be performed even on a document image in which horizontally written text and vertically written text exist. FIG. 8 is a schematic diagram representing an example of scanning the document image in each line direction.

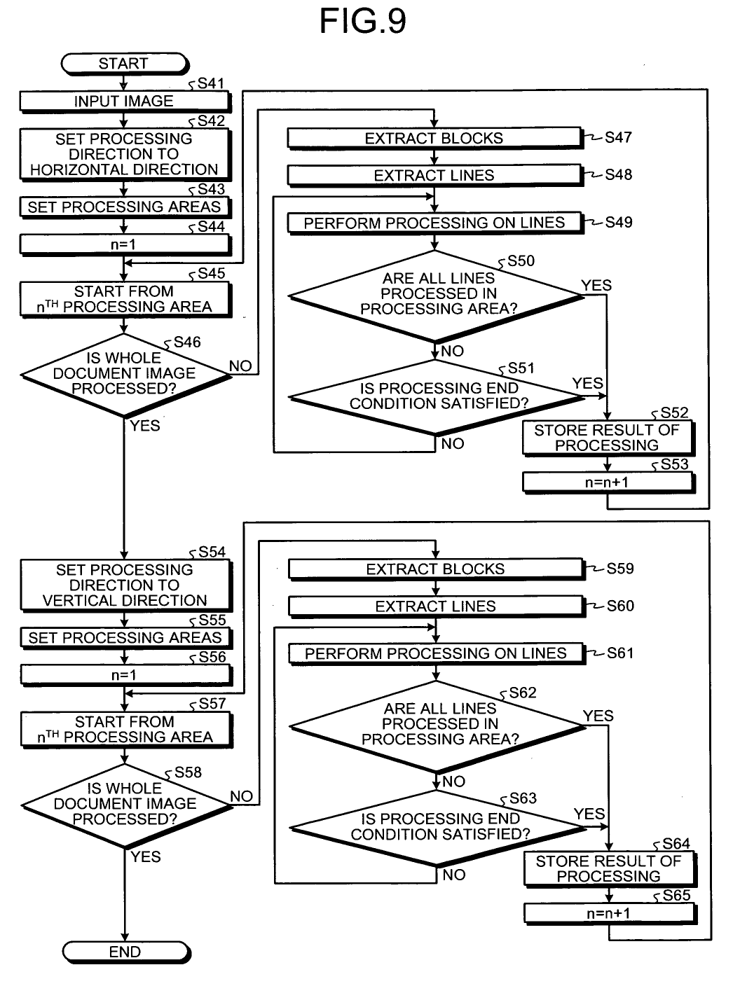

A processing procedure in the third example is explained referring to FIG. 9. FIG. 9 is a flowchart of the processing procedure according to the third example.

In the third example, the predetermined processing is performed considering both of the horizontal writing and the vertical writing, and when it is judged that the processing end condition is satisfied, the predetermined processing in operation on a processing area is ended to transfer to the processing to the next processing area.

The document image stored in the storage unit 3 by the image input unit 10 is read out from the storage unit 3 and is input to the document-image dividing unit 20, or the document image is directly input to the document-image dividing unit 20 by the image input unit 10 (Step S41).

The document-image dividing unit 20 sets a line direction in which the predetermined processing is performed (a processing direction) to the horizontal direction by a line direction setting unit (not shown) (Step S42).

The document-image dividing unit 20 sets processing areas according to the line direction (the horizontal direction) by the processing-area setting unit 21. Specifically, the document-image dividing unit 20 divides the document image into a plurality of areas in the line direction, and temporarily stores the divided areas as the processing areas (Step S43). At this time, a number is assigned to each processing area, and a first processing area is processed (Steps S44 and S45).

Before performing the block extraction processing (Step S47) and the line extraction processing (Step S48) on the first processing area, the document-image dividing unit 20 judges whether the whole document image (all the processing areas) is processed (Step S46). If there is a plurality of processing areas, the document-image dividing unit 20 judges that not the whole document image is processed, i.e., there is a non-processed processing area remained (“No” at Step S46), and a system control proceeds to Step S47.

The document-image dividing unit 20 performs the block extraction processing on the first processing area by the block extracting unit 22 (Step S47). Specifically, the document-image dividing unit 20 extracts blocks each circumscribing a pixel connected component, and records coordinates of the blocks. Thereafter, the document-image dividing unit 20 performs the line extraction processing on the first processing area by the line extracting unit 23 (Step S48). Specifically, the document-image dividing unit 20 couples adjacent blocks to form lines, and records coordinates of the lines.

The processing unit 30 performs the predetermined processing such as the OCR processing by the OCR unit 31 and the character-orientation judging processing by the character-orientation judging unit 32 on the lines extracted by the line extraction processing (Step S49).

The processing unit 30 judges whether the predetermined processing is performed on all the lines in the first processing area (Step S50).

When the processing unit 30 judges that the predetermined processing is performed on all the lines in the first processing area (“Yes” at Step S50), a result of the predetermined processing is stored in the storage unit 3 (Step S52). Then, a second processing area is taken as a target (Step S53), and the processing is performed on the second processing area from Step S45 in the same manner as the above.

When the processing unit 30 judges that the predetermined processing is not performed on all the lines in the first processing area (“No” at Step S50), the processing unit 30 judges whether the processing end condition to end the predetermined processing in operation is satisfied (Step S51).

As described above, the processing end condition includes the case in which a desired result can be obtained while the predetermined processing is performed, examples of which are a case in which a result of the OCR processing coincides with the preset keyword, and a case in which the number of lines whose character orientation is judged exceeds the predetermined threshold.

When the processing unit 30 judges that the processing end condition is not satisfied (“No” at Step S51), the control system returns to Step S49, and the processing unit 30 continues the predetermined processing to non-processed lines in the first processing area.

When the processing unit 30 judges that the processing end condition is satisfied (“Yes” at Step S51), the processing unit 30 ends the predetermined processing in operation, and the control system proceeds to Step S52 at which a result of the predetermined processing performed thus far is stored in the storage unit 3. Then, the second processing area is taken as a target (Step S53), and the processing is performed on the second processing area from Step S54 in the same manner as the above. In other words, when it is judged that the processing end condition is satisfied, the predetermined processing in operation on the processing area is ended, and a target for processing is transferred to the next processing area.

When it is judged that the whole document image (all the processing areas) is processed, i.e., there is no non-processed processing area remained (“Yes” at Step S46), the document-image dividing unit 20 sets the line direction in which the predetermined processing is performed on the vertical direction by the line direction setting unit (Step S54).

The document-image dividing unit 20 sets processing areas according to the line direction (the vertical direction) by the processing-area setting unit 21 (Step S55). Thereafter, the processing at Steps S56 to S65 is performed in the same manner as those at Steps S44 to S53.

When it is judged that the whole document image (all the processing areas) is processed, i.e., there is no non-processed processing area remained (“Yes” at Step S58), the entire operation is finished.

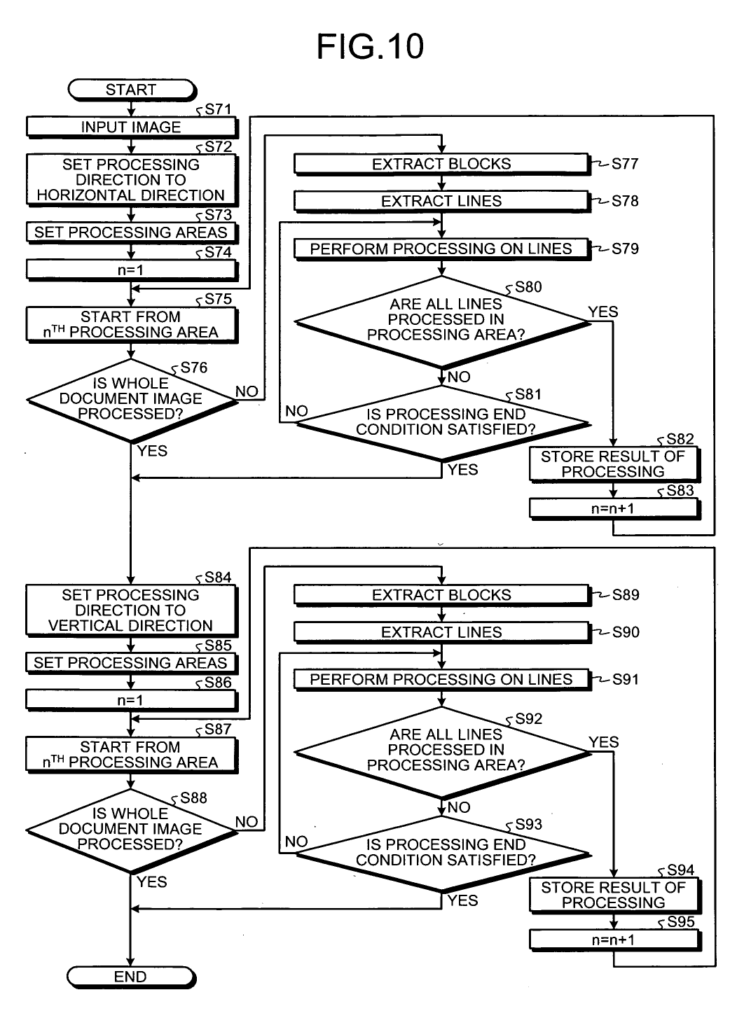

A processing procedure in a fourth example is explained referring to FIG. 10. FIG. 10 is a flowchart of the processing procedure according to the fourth example.

In the fourth example, the predetermined processing is performed considering both of the horizontal writing and the vertical writing, and when it is judged that the processing end condition is satisfied, the predetermined processing in operation on a processing area is ended but the processing is not transferred to the next processing area.

The processing at Steps S71 to S83 shown in FIG. 10 in the fourth example is performed in the same manner as those at Steps S41 to S53 shown in FIG. 9 in the third example except the following point, so that the explanations of the same processing are omitted. In the fourth example, when the processing unit 30 judges that the processing end condition is satisfied (“Yes” at Step S81), the predetermined processing in operation is ended, and the line direction setting unit sets the line direction in which the predetermined processing is performed to the vertical direction without transferring to the processing to the next processing area. (Step S84). Thereafter, the processing at Steps S85 to S95 shown in FIG. 10 is performed in the same manner as those at Steps S55 to S65 in FIG. 9 in the third example except the following point (the explanations of the same processing are omitted). In the fourth example, when the processing unit 30 judges that the processing end condition is satisfied (“Yes” at Step S93), the predetermined processing in operation is ended, and the entire operation is finished without transferring to the processing to the next processing area. In addition, when the processing unit 30 judges that the whole document image (all the processing areas) is processed, i.e., there is no non-processed processing area remained (“Yes” at Step S88), the entire operation is finished.

It is sufficient that the upper limit of the number of blocks in the processing area is set based on the case in which normally used minimum-size characters fill the processing area. However, the number of blocks may exceed the upper limit when the document image is not a text image, but a pointillist drawing or a background, for example.

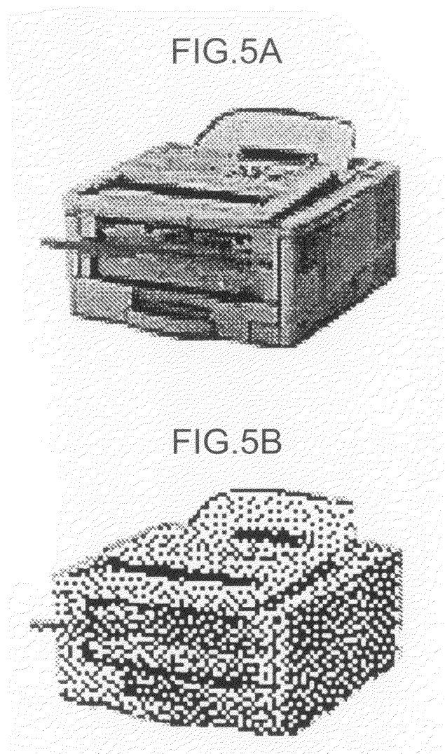

FIG. 5A is a schematic diagram of an example of a color image, and FIG. 5B is a schematic diagram of an example of a binary halftone image.

The binary halftone image shown in FIG. 5B is, formed by fine dots with high density, so that the number of black pixels is extremely large. Therefore, blocks circumscribing the black pixels are also generated in large numbers, which may result in exceeding the upper limit of the number of the blocks to be stored. In this case, the block extraction processing to the whole processing area is not finished, so that it is difficult to obtain a normal result of the line extraction processing. Moreover, processing amount becomes extremely large for processing a large number of blocks.

For solving the problem, the control unit 33 judges whether the processing end condition is satisfied between the block extraction processing and the line extraction processing in each of the flowcharts in FIGS. 6, 7, 9, and 10 in the first to fourth examples. The processing end condition includes a case in which a document image is not suitable as a target for processing such as a case in which the control unit 33 judges that the processing end condition is satisfied when the number of the blocks in the processing area exceeds a predetermined threshold.

When the processing end condition is satisfied, the control unit 33 judges that the document image in the processing area is not a text document, and the processing is transferred to the next processing area without performing the line extraction processing on the processing area. In other words, if the control unit 33 judges that a result of the line extraction processing cannot be obtained, the processing in operation is ended to avoid unnecessary computations, and the processing is transferred to the next processing area. Therefore, it is possible to effectively perform the line extraction processing in view of processing speed and computational resource. When the processing end condition is not satisfied, the line extraction processing is performed on the processing area.

It is not often the case that characters present uniformly on the whole document image, so that it is not appropriate to determine to end the processing based on a processing result of the block extraction processing of only one line (or one processing area). Therefore, the control unit 33 is made to determine the processing result if it coincides with a processing result of any other line (or any other processing area), so that the possibility of incorrectly judging the document image based on a local processing result in the document image can be reduced.

The condition of the document image can be recognized more clearly by increasing the number of times that a processing result of a line (or a processing area) needs to coincide with that of any other line (or any other processing area) (hereinafter “the number of times of coincidence”), resulting in increasing reliability of a processing result. A user can specify the number of times of coincidence as a processing-result determining condition using the keyboard 6 based on reliability that the user requires, so that a processing result can be determined early while desired reliability is secured, which is advantageous. The control unit 33 determines a processing result of a line (or a processing area) when the number of times of coincidence reaches a specified number of times.

In the case of specifying the number of times of coincidence, a large difference occurs in processing time between the following two cases A and B.

A: a processing result of a first processing line (or a first processing area) coincides with a processing result of the next processing line (or the next processing area)

B: a processing result of the first processing line (or the first processing area) coincides with a processing result of the last processing line (or the last processing area)

Therefore, for surely shortening the processing time, it is also effective that the control unit 33 judges the necessity of performing the predetermined processing on other lines (or other processing areas) according to the condition that processing results of the processing continuously performed on lines (or processing areas) coincide with each other. With this condition, it is sufficient to check the number of times of continuous coincidence, so that the processing result can be determined without waiting processing results of the processing performed after the number of times of continuous coincidence is satisfied.

Even when a user specifies the number of times of continuous coincidence as the processing-result determining condition, a processing result can be determined early while desired reliability is secured.

A pointillist drawing as shown in FIG. 5B or isolated points regarded as noise are also targets for the block extraction processing because they are each formed by connecting pixels. By performing the block extraction processing, the size of pixels that are connected can be assumed based on the size of a block circumscribing the connected pixels. The number of pixels becomes larger as the resolution increases among isolated points that are physically the same size. For example, one dot of an isolated point with the scanning resolution of 200 dpi is equivalent to two-by-two dots of an isolated point with the scanning resolution of 400 dpi. For effectively extracting lines, an isolated point that is too small as a character image does not need to be processed. Therefore, the size of a block excluded as a target for processing without condition is changed according to the resolution.

The size of the block to be excluded can be set in advance based on the range of the size of a target character desired by a user, and can be proportionally changed according to the resolution. For example, if the user targets only large size characters, the size of the block to be excluded can be set large.

After the block extraction process, blocks that are smaller than the block to be excluded are eliminated as a target for processing.

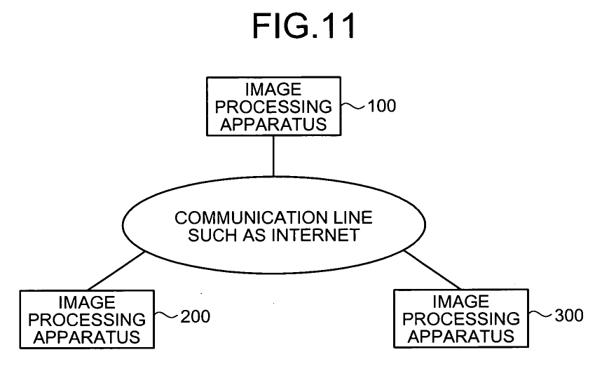

Furthermore, any one of the above-described image processing methods can be easily embodied by recording a computer program for processing procedures in a general program language in any kind of storage medium such as a flexible disk, a CD-ROM, a DVD-ROM, a magnet optical disc (MO), and the like, and allowing a PC of the image processing apparatus to read the computer program. The computer program can be directly read by PCs of image processing apparatuses 200 and 300 through a network such as the Internet and Intranet as shown in FIG. 11. FIG. 11 is a schematic diagram of an example of the image processing apparatuses 100, 200, and 300 provided on the network.

According to the embodiment and the examples, the image processing is performed every predetermined processing area in an input image as a target for processing. Every time the image processing is performed on a processing area in the input image, it is judged whether the processing end condition to end the image processing on the processing area is satisfied. When a result of the image processing satisfies the processing end condition, the image processing on non-processed processing areas is stopped. Therefore, the processing speed is further improved.

The embodiment and the examples described above are useful in a document processor such as an image forming apparatus and a scanner, and are especially suitable for adapting to an image processing apparatus (a document processor) without large storage capacity.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an image processing unit that performs a predetermined image processing on each of a plurality of areas of an input image;
a judging unit that judges whether a result of image processing performed by the image processing unit on an area satisfies a certain processing end condition;
a stopping unit that causes the image processing unit to stop performing the image processing when judgment of the judging unit is affirmative; and
an output unit that outputs the image processing result.

2. The image processing apparatus according to claim 1, wherein
the judging unit judges whether a result of image processing performed by the image processing unit on each of a plurality of areas satisfies a certain processing end condition, and
the stopping unit causes the image processing unit to stop performing the image processing when judgment of the judging unit is affirmative.

3. The image processing apparatus according to claim 2, wherein
the judging unit judges whether a result of image processing performed by the image processing unit on each of a plurality of areas satisfies a certain processing end condition in succession, and
the stopping unit causes the image processing unit to stop performing the image processing when judgment of the judging unit is affirmative.

4. The image processing apparatus according to claim 1, wherein
the input image is a text image of a text document,
the predetermined area is a line of the text document, and
the judging unit judges whether an image processing result of the image processing on the line in the text document satisfies the processing end condition.

5. The image processing apparatus according to claim 4, wherein the judging unit judges whether the image processing result satisfies the processing end condition based on information on arrangement of blocks in a line.

6. The image processing apparatus according to claim 4, wherein the judging unit judges whether the image processing result satisfies the processing end condition based on information on characters in blocks in a line.

7. The image processing apparatus according to claim 5, wherein the image processing unit obtains orientations of characters in a line as the information on arrangement, and the judging unit judges that the processing end condition is satisfied when number of lines whose character orientation is obtained exceeds a threshold.

8. The image processing apparatus according to claim 6, wherein the image processing unit obtains a character string as the information on characters, and the judging unit judges that the processing end condition is satisfied when the character string coincide with a preset keyword.

9. The image processing apparatus according to claim 5, wherein the image processing unit obtains number of the blocks in a line, and the judging unit judges that the processing end condition is satisfied when the number of the blocks in the line in the predetermined area exceeds a threshold.

10. An image processing method comprising:
performing a predetermined image processing on each of a plurality of areas of an input image;
judging whether a result of image processing performed at the performing on an area satisfies a certain processing end condition;
stopping the performing when judgment at the judging is affirmative; and
outputting a result of the image processing performed at the performing.

11. The image processing method according to claim 10, wherein
the judging includes judging whether a result of image processing performed at the performing on each of a plurality of areas satisfies a certain processing end condition, and
the stopping includes stopping the performing when judgment at the judging is affirmative.

12. The image processing apparatus according to claim 11, wherein
the judging includes judging whether a result of image processing performed at the performing on each of a plurality of areas satisfies a certain processing end condition in succession, and
the stopping includes stopping the performing when judgment at the judging is affirmative.

13. The image processing method according to claim 10, wherein
the input image is a text image of a text document,
the predetermined area is a line of the text document, and
the judging includes judging whether an image processing result of the image processing on the line in the text document satisfies the processing end condition.

14. The image processing method according to claim 13, wherein the judging includes judging whether the image processing result satisfies the processing end condition based on information on arrangement of blocks in a line.

15. The image processing method according to claim 13, wherein the judging includes judging whether the image processing result satisfies the processing end condition based on information on characters in blocks in a line.

16. The image processing method according to claim 14, wherein the performing includes obtaining orientations of characters in a line as the information on arrangement, and the judging includes judging that the processing end condition is satisfied when number of lines whose character orientation is obtained exceeds a threshold.

17. The image processing method according to claim 15, wherein the performing includes obtaining a character string as the information on characters, and the judging includes judging that the processing end condition is satisfied when the character string coincide with a preset keyword.

18. The image processing method according to claim 14, wherein the performing includes obtaining number of the blocks in a line, and the judging includes judging that the processing end condition is satisfied when the number of the blocks in the line in the predetermined area exceeds a threshold.

19. A computer program product comprising a computer usable medium having computer readable program codes embodied in the medium that, when executed, causes a computer to execute:
performing a predetermined image processing on each of a plurality of areas of an input image;
judging whether a result of image processing performed at the performing on an area satisfies a certain processing end condition;
stopping the performing when judgment at the judging is affirmative; and
outputting a result of the image processing performed at the performing.
